(19) United States
(12) Patent Application Publication
(10) Pub. No.: US 2009/0208608 A1
(43) Pub. Date: Aug. 20, 2009

(54) FLAVORED SOFTGEL CAPSULE AND METHOD OF MANUFACTURING THEREOF

(75) Inventors: Beverly EMERSON, Ferndale, WA (US); Benoit MILETTE, Olds (CA)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: BARLEAN'S ORGANIC OILS, LLC, Ferndale, WA (US)

(21) Appl. No.: 12/034,595

(22) Filed: Feb. 20, 2008

(51) Int. Cl. A23L 1/05; A23L 1/00; A23P 1/08; A23P 1/04; A23L 1/22

(52) U.S. Cl. 426/89; 99/485; 426/576

(57) ABSTRACT

Disclosed herein is a softgel capsule, and methods of producing a softgel capsule, comprising a gelatin shell and a fill. Prior to encapsulation, a flavored composition is applied to the gelatin sheets used to encapsulate the fill.

### FIELD OF THE INVENTION

The present invention relates to flavored softgel capsules and methods of manufacturing them.

### BACKGROUND OF THE INVENTION

Soft gel capsules have two principal components: a fill of a medicament, vitamin, or other dietary and nutritional supplement or the like; and a gelatin shell encapsulating the fill. In softgel capsules where the fill is not tasteful (e.g., if the fill is fish oil), the fill may be flavored to mask the taste of the fill.

### SUMMARY OF THE PREFERRED EMBODIMENTS

In accordance with a first aspect of the present invention, there is provided a method of making a flavored softgel. The method preferably comprises forming a gelatin sheet (aka “ribbon”) and applying a flavored composition to at least a portion of the gelatin sheet. The resulting sheets are then used to encapsulate a fill.

In accordance with another aspect of the present invention, there is provided an apparatus for applying a flavored composition to sheets of gelatin. The apparatus includes a mechanism for generating sheets of gelatin, a vessel for holding the flavored composition, a roller mechanism having perforations associated therewith, the roller mechanism being adjacent to the sheets of gelatin; and a pump mechanism for delivering the flavored composition from the vessel to the roller mechanism.

In accordance with another aspect of the present invention, there is provided an apparatus for applying a flavored composition to sheets of gelatin. The apparatus includes a vessel for the flavored composition, a sprayer for the flavored composition, and a pump for delivering the flavored composition from the vessel, through the sprayer, and onto the sheets of gelatin.

In accordance with another aspect of the present invention, there is provided a method of making a softgel, comprising the steps of drying softgel capsules and polishing softgel capsules. A flavored composition may be added to the step of drying and/or the step of polishing the capsules.

In accordance with another aspect of the present invention, there is provided a method of making a softgel comprising the step of applying a flavored composition to a capsule after a fill is encapsulated. The flavored composition may be applied as the capsule is dried and/or as the capsule is polished.

### BRIEF DESCRIPTION OF THE DRAWINGS

The invention may be more readily understood by referring to the accompanying drawings in which:

FIG. 1 is a top plan view of a flavored capsule of the present invention;

FIG. 2 is a flow diagram of a method of making a flavored capsule of the present invention;

FIG. 3 is a side plan view of the apparatus of the present invention;

FIG. 4 is a perspective view of one embodiment of the roller mechanism used in the apparatus of FIG. 3; and

FIG. 5 is a perspective view of another embodiment of the roller mechanism used in the apparatus of FIG. 3.

Like numerals refer to like parts throughout the several views of the drawings.

### DETAILED DESCRIPTION OF THE PREFERRED EMBODIMENTS

As shown in the drawings, for purposes of illustration, the invention is embodied in a flavored capsule and a method of making a flavored capsule.

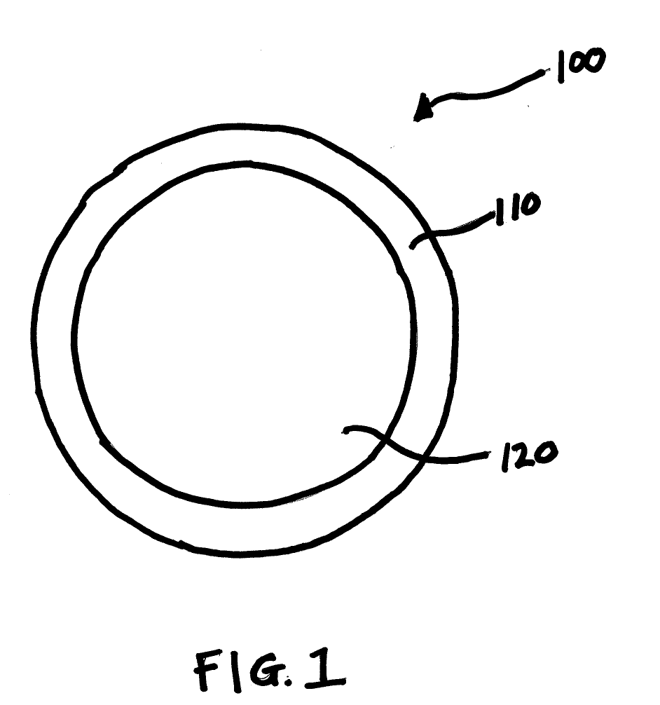

As shown in FIG. 1, in a preferred embodiment, capsule 100 is a flavored soft gel capsule. Soft gel capsule 100 preferably includes a gelatin shell 110 and a fill material 120. Gelatin shell 110 includes materials such as gelatin, water, a plasticizer, coloring, flavoring, and the like. In one illustrative embodiment, the fill material 120 includes an organic oil such as fish oil. However, the fill material 120 may be any other medicament, vitamin, and/or dietary and nutritional supplement, or the like, including without limitation the following: any source(s) of omega-3 fatty acids such as fish oil, flax oil, and/or vegetable oils (such as chia seeds, walnut oil, hemp seed, and soybean); vitamins A, B₁, B₂, B₃, B₅, B₆, B₇, B₉, B₁₂, C, D, D₂, D₃, E and/or K; omega-3 fatty acids such as alpha-linolenic acid and eicosapentaeonoic acid; methylsulfonyl methane; S-adenosyl methionine; selenium; minerals; amino acids; amino acid derivatives; biotin; folic acid; calcium; chromium chloride; copper sulfate; magnesium; manganese; potassium; silica; zinc; choline bitartrate; inositol; dimethylglycine; plant derived ionic trade materials; bioflavonoids such as hesperiden and rutin; essential fatty acid complexes such as lecithin, borage oil, flax seed oil, evening primrose oil; herbal medicaments such as eleuthero root, ginger, noni, yerba mate; fruit and vegetable extracts; soy protein; weight loss medicaments; pain medicaments; cholesterol medicaments; human growth hormone releasers; coenzyme Q10; skin care medicaments; anti-oxidants; bone medicaments; polyphenols such as grape seed extract, grape skin extract, green tea extract, strawberry extract, raspberry extract, bilberry extract, and red wine powder; carotenoids such as beta-carotene, astaxanthin, lutein, xeanthin, and vegetable and animal-based waxes; and/or mixtures thereof.

In a preferred embodiment, the gelatin shell 110 is prepared from a gel mass (not shown) including a flavoring such as a citrus flavoring. The gel mass includes gelatin; however, other film formers well-known in the art, such as non-animal films, may also be used.

The flavoring may be any water-soluble and/or oil-soluble flavoring as is known in the art, or a mixture thereof. Examples of flavorings include the following: lemon; strawberry; orange; grape; pineapple; berry; cinnamon; wintergreen; spearmint; any source of diacetyl, isoamyl acetate, cinnamic aldehyde, ethyl propionate, limonene, allyl hexanoate, ethyl maltol, methyl salicylate, and/or benzaldehyde; citric acid; tartaric acid; amaretto flavor; apple flavor; apricot flavor; bubble gum flavor; butter flavor; caramel flavor; coffee flavor; chocolate flavor; hazelnut flavor; lemon oil; licorice flavor; lime oil; tropical punch flavor; watermelon flavor; maple flavor; or mixtures thereof.

If, for example, a water-soluble flavoring is used, an emulsifier may be added to the lubrication oil (or any other carrier) in the flavored composition. Examples of emulsifiers include, without limitation, the following: glycerin fatty acid esters, acetic acid esters of monoglycerides, lactic acid esters of monoglycerides, citric acid esters of monoglycerides, succinic acid esters of monoglycerides, diacetyl tartaric acid esters of monoglycerides, polyglycerol esters of fatty acids, polyglycerol polyricinoleate, sorbitan esters of fatty acids, propylene glycol esters of fatty acids, sucrose esters of fatty acids, lecithin, and/or enzyme digested lecithin, or the like. The gel mass may be prepared by ways well known in the art. Typically, the gel mass employs from about 1% to about 6% by weight of the flavoring. However, the gel mass may employ more or less flavoring without departing from the scope of the present invention.

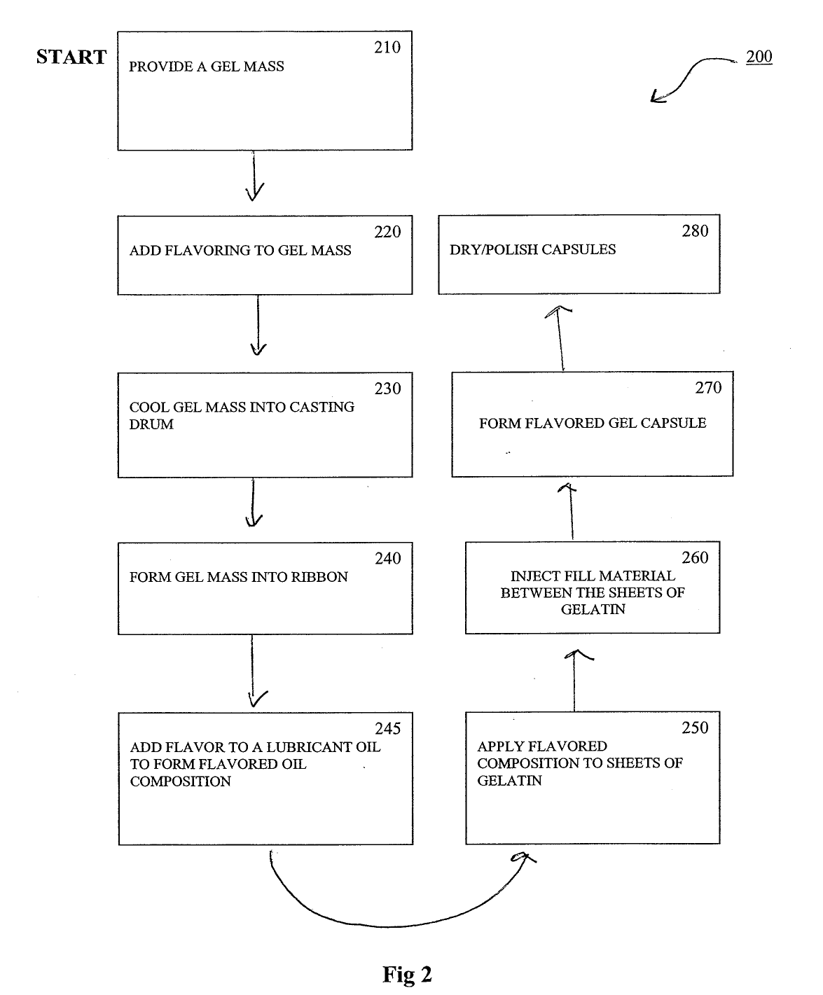

FIG. 2 shows a preferred embodiment of the process 200 of the present invention. Process 200 includes the step 210 of providing a gel mass. At step 220, the flavoring is added to the gel mass. The gel mass with the flavoring is cooled onto a casting drum(s) and/or extruded at step 230. For example, the gel mass may be cast onto two opposing chilled drums (either air or water cooled or a combination of both). The gel mass is formed and/or pressed into sheets or ribbons of gelatin in step 240, by methods known in the art.

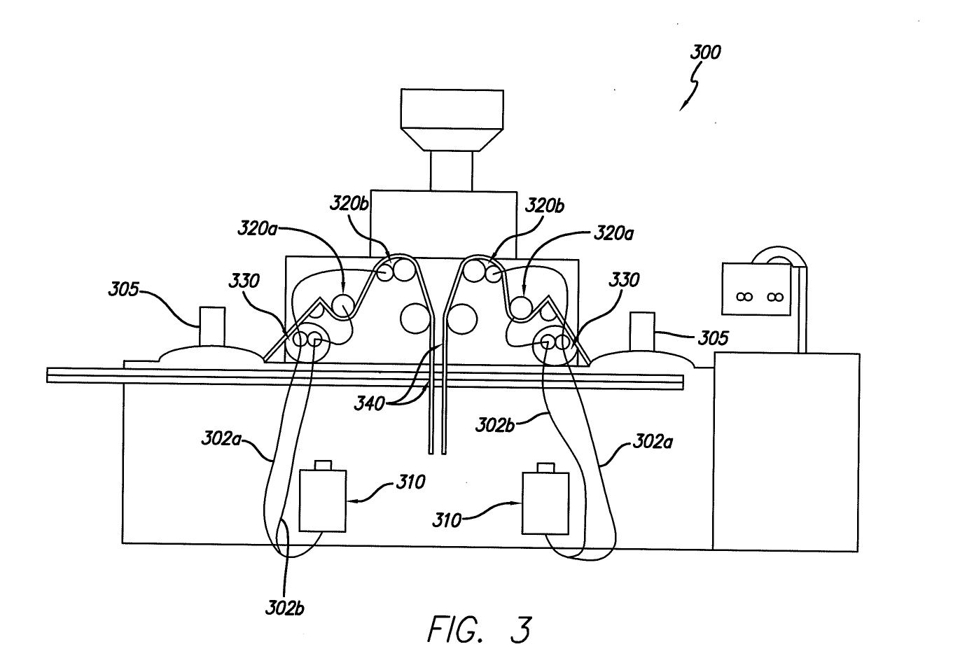

In accordance with one preferred embodiment of the present invention, at step 245, a flavoring is added to a lubricant oil, thereby forming a flavored composition. The flavored composition is applied, coated, or sprayed onto, to at least a portion of at least one sheet of gelatin in step 250. An apparatus for coating at least a portion of at least one sheet of gelatin with the flavored composition is described in FIG. 3 and as follows.

FIG. 3 shows apparatus 300 for use with the process of the present invention. Preferably, apparatus 300 includes a pair of mechanisms for generating sheets of gelatin 305, a pair of vessels 310 for holding the flavored composition, a pair of pump mechanisms 330, a pair of roller mechanisms 320a, and a pair of roller mechanisms 320b. For ease of description, each single vessel/mechanism in the pair will also be referred to by the foregoing numbers. For example, the pair of pump mechanisms may be referred to individually as 330 or as a pair as 330. Accordingly, it is to be understood that the discussion that pertains to one vessel and/or mechanism may refer to the other vessel and/or mechanism in the pair as well. Moreover, each of the roller mechanisms that is configured to apply the flavored composition to the top of a portion of at least one sheet of gelatin include an “a” suffix, and each of the roller mechanisms configured to apply the flavored composition to the bottom of at least a portion of one sheet of gelatin include a “b” suffix. In a preferred embodiment, apparatus 300 applies the flavored composition to both the top and the bottom of the sheets of gelatin. In addition, the roller mechanisms may be referred to generically as 320.

In another embodiment, apparatus 300 may include any other number of mechanisms for generating sheets of gelatin, vessels, pump mechanisms, and/or roller mechanisms, without departing from the scope of the present invention. For example, in one embodiment, apparatus 300 may omit roller mechanism 320, and the flavored composition may be applied by spraying it onto the sheets of gelatin. Apparatus 300 may omit roller mechanism 320a or 320b and only apply the flavored composition to the top or the bottom (but not both) of the sheets of gelatin. As shown in FIG. 3, apparatus 300 is configured to apply coating to two sheets of gelatin (each referred to as “340” and collectively referred to as “340”). However, apparatus 300 may be configured to process more or less sheets of gelatin any given time.

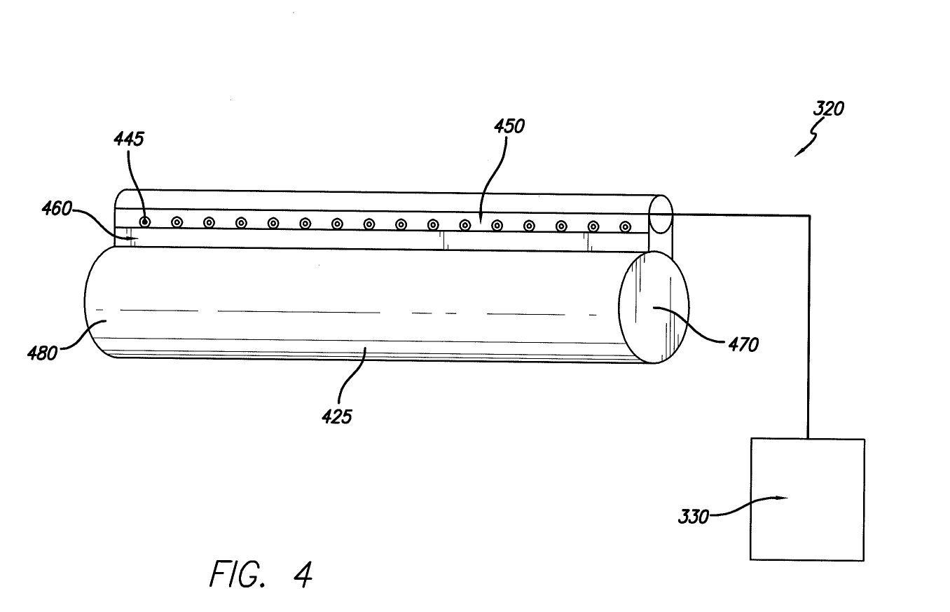

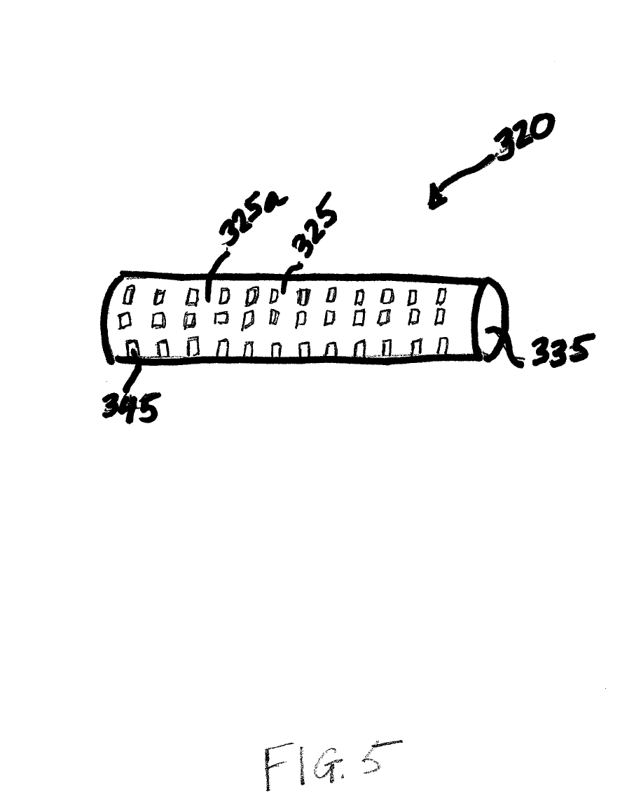

The vessel 310 preferably holds the flavored composition (not shown). The flavored composition may be a flavored oil composition or a flavored water-based composition. For example, the flavored composition may comprise a food-grade lubricant such as mineral oil or Miglyol (fractionated coconut oil/medium-chain triglycerides, available from Hulls America) and oil-soluble or water-soluble flavoring. The vessel 310 is connected to pump mechanism 330 by conduits 302a and 302b. Each of the conduits 302a and 302b carries the flavored composition from the vessel 310 to the pump mechanism 330. The pump mechanism 330 delivers the flavored composition from the vessel 310 to the roller mechanism 320. Preferably, the pump mechanism 330 delivers the flavored composition at a rate of speed sufficient to provide lubrication and flavoring to the gelatin sheets. Preferably, conduit 302a delivers the flavored composition to roller mechanism 320b, and conduit 302b delivers the flavored composition to roller mechanism 320a. Preferably, the roller mechanism 320 is adjacent to one or more sheets, or ribbons, of gelatin 340. Preferably, the roller mechanism 320 has perforations (not shown in FIG. 3, but shown in FIGS. 4 and 5) associated therewith.

Two embodiments of the roller mechanism 320 for use with the apparatus 300 of the present invention are described as follows. However, as one skilled in the art would appreciate, the invention is not limited to the roller mechanisms 320 described below, and may be used with any mechanism for applying and/or coating material to gelatin sheets. In addition, apparatus 300 is not limited to the use of one embodiment of the roller mechanism described herein. As such, both embodiments may be included in the apparatus 300, without departing from the scope of the present invention.

In one preferred embodiment, and as shown in FIG. 5, the roller mechanism 320 comprises a hollow inside or body 335 having an outer surface 325. The outer surface 325 has a plurality of perforations 345. In an embodiment, each of the perforations may be about 5 to about 200 microns in pore size. The roller mechanism 320 may be made from UHMW Polyethylene, PE co-polymers, Polypropylene, or the like. In another embodiment, each of the perforations may be more or less in size, or may be of different sizes and/or the roller mechanism 320 may be made from any other material known in the art.

In this embodiment, the pump mechanism 330 (shown in FIG. 3) delivers the flavored composition to the hollow, or inside, of the hollow body 335. The flavored composition is pumped at a specific speed and/or pressure through the hollow body 335 and to the plurality of perforations 345. Preferably, the flavored composition passes through the plurality of perforations 345 in the hollow body 335 and onto the sheets of gelatin 340. The roller mechanism 320 is adjacent to the sheets of gelatin 340, and may be in contact with the sheets of gelatin 340.

In another preferred embodiment, as shown in FIG. 4, the roller mechanism 320 includes an application tube 450, a roller 480, and a felt pad 460. Preferably, the application tube 450 is disposed adjacent the roller 480. The application tube 450 includes a plurality of perforations 445. The pump mechanism 330 (shown in FIG. 3) delivers the flavored composition to the application tube 450. The flavored composition passes through the perforations 445 in the application tube 450 and onto the felt pad 460. The felt pad 460 is maintained in contact with the sheets of gelatin 340. As such, the flavored composition is preferably applied or coated to the sheets of gelatin 340 (not shown in FIG. 4) as they come in contact with the felt pad 460.

Referring now to FIG. 2, once the flavored composition is applied to at least a portion of at least one sheet of gelatin, a fill material may be pumped under pressure, or gravity-fed, into place where the sheets of gelatin are brought together between rotating or reciprocating dies with which the gelatin sheets are in contact. The dies have cavities formed on their surfaces. The pumping of fill material between the gelatin sheets is carefully timed in synchronism with die movement so that a metered amount of fill material is discharged between the sheets of gelatin to bulge into adjacent opposed die cavities. The sheets come together around a controlled movement of fill material as the dies continue to move and the films are sealed together by applying pressure and/or heat at the dies which then coact to cut the sheets at the seal. The then fully-enclosed-by-gelatin fill dosage quantity separates from the sheets as a separate article, or capsule in step 270.

Water from the gelatin evaporates as the capsules are dried and/or polished in step 280, as is well-known in the art and as is described in U.S. Patent Application Publication No. 2006/0292217, the entire contents of which are herein incorporated by reference.

In an embodiment of the invention, the flavored composition may be applied to/brushed onto the capsules in step 280. The flavored composition may be added to the drying and/or polishing step, depending on the type of drying system used. Preferably, the flavored composition is applied to the capsules via lint-free towels or towels substantially free of lint. In another embodiment, the flavored composition may be applied to/brushed onto the capsules in the drying and/or polishing step by any means known in the art.

In one embodiment of the invention, the capsules may be dried in step 280 through a conventional capsule drying system. The capsule drying system may include a sequential series of drying tumbler baskets that are located in a controlled environment conducive to drying the soft gelatin capsules. The freshly-formed capsules enter a tumbler basket. The tumbler rotates continuously to provide air-flow over the capsule bed, thus promoting moisture removal from the capsule's gel shell. Preferably, lint-free or substantially lint-free towels are introduced to the tumblers to apply/brush the flavored composition onto the capsules. The flavored composition may thereby bleed through the matrix of the gelatin shell of the capsules. In another embodiment, the capsules may be dried by passing them through a secession of rotating drums and placing them onto trays placed in environmentally controlled rooms to continue the drying process. Towels including the flavored composition may be added to the rotating drums, thereby applying/brushing the flavored composition to the capsules as they come into contact with them.

In another embodiment, steps 250 and 260 may be performed simultaneously. For example, as the sheets of gelatin are pressed, the flavored composition may be applied to at least a portion of at least one of the sheets of gelatin. In addition, the flavoring in each of step 220 and step 245 may be the same or different. The amount of the flavoring added in step 220 may be the same as the amount of flavoring applied in step 245, or may be different. More than one type of flavoring may be added in each of step 220 and step 245. In an alternate embodiment, step 220 may be omitted, without departing from the scope of the present invention. In yet another embodiment, steps 220 and 250 may be omitted, and the flavored composition may be added in step 280 only.

In another embodiment, step 245 may be modified. The flavoring may be directly added to at least a portion of one of the sheets of gelatin, without being added to the lubricant oil first. As such, the flavoring may be oil-soluble or may be water-soluble. If water-soluble, an emulsifier may be mixed with the flavoring. Likewise, the lubricant oil may be omitted, without departing from the scope of the present invention.

Preferably, the concentration of flavoring in the gelatin shell 110 is greater than the concentration of flavoring in the gel mass used to make the gelatin shell 110. As such, the final concentration of flavoring in the shell of the softgel is greater than it would be if the flavored composition were not applied to the gelatin sheets.

Preferably, the flavored composition includes a flavoring and a carrier such as oil or water. In a preferred embodiment, the concentration of flavoring in the flavored composition is from about 2% by weight to about 40% by weight of the composition, with the remainder being a carrier such as oil or water. If oil is used, mineral oil or migli oil (medium chain triglycerides) are preferred. In a more preferred embodiment, the concentration of flavoring in the flavored composition is from about 5% by weight to about 35% by weight of the composition, with the remainder being a carrier such as oil or water. In a highly preferred embodiment, the concentration of flavoring in the flavored composition is about 25% by weight of the composition, with the remainder being a carrier such as oil or water. In one aspect of this highly preferred embodiment, the concentration of flavoring is about 25% by weight, and the concentration of mineral oil, or other carrier, is about 75% by weight. However, the concentration of flavoring in the flavored composition may be more or less than the foregoing, without departing from the scope of the present invention.

To further illustrate the present invention, it should be appreciated that by employing the process of the present invention using the flavored composition, the concentration of the flavoring in the final gelatin shell is higher than if the gel mass were processed without using the flavored composition and solely relying upon the flavoring added to the gel mass and/or fill. Preferably the concentration of flavoring in the gelatin shell is increased by 15% by the present invention, more preferably by at least 30%, and even more preferably by at least 40%, compared to adding the flavoring in the gel mass/fill alone. In addition, the present invention improves the odor and taste of the capsule.

The embodiments described above are exemplary embodiments of the present invention. Those skilled in the art may now make numerous uses of, and departures from, the above-described embodiments without departing from the inventive concepts disclosed herein. Accordingly, the present invention is to be defined solely by the scope of the following claims.

What is claimed is:

1. A method of making a softgel, comprising:
(a) forming gelatin sheets; and
(b) applying a flavored composition to at least a portion of at least one of the gelatin sheets.

2. The method of claim 1, wherein the flavored composition is applied to the sheets before the sheets encapsulate a fill.

3. The method of claim 1, wherein the flavored composition is a flavored oil composition.

4. The method of claim 1 wherein the flavored composition comprises from about 5% to about 35% by weight of a flavor with the remainder being a carrier such as oil or water.

5. A softgel capsule comprising a gelatin shell made from gelatin sheets having applied thereto a flavored composition, wherein a gel mass used to form the gelatin shell has a concentration of flavoring, and wherein the final concentration of flavoring in the shell of the softgel is greater than it would be if the flavored composition were not applied to the gelatin sheets.

6. The softgel of claim 5, wherein the flavoring is oil-soluble.

7. The softgel of claim 5, wherein the flavoring is water-soluble.

8. The softgel of claim 5, wherein the percentage by weight of flavoring in the flavored composition is from about 5% to about 35% by weight.

9. A method of making a softgel comprising the step of applying a flavored composition to sheets of gelatin before a fill is encapsulated.

10. The method of claim 9 wherein the flavored composition comprises from about 5% to about 35% by weight percent of flavoring.

11. The method of claim 10 wherein the flavored composition includes an oil.

12. The method of claim 10 wherein the flavored composition includes a lubrication oil and citrus flavoring.

13. The method of claim 12, wherein the lubrication oil is a mineral oil.

14. The method of claim 10 wherein the flavoring in the flavored composition is chosen from citrus flavoring, berry flavoring, apple flavoring, and mixtures thereof.

15. The method of claim 9, wherein the gelatin sheets have a top and bottom, and wherein the flavored composition is applied to the top of the sheets of gelatin.

16. The method of claim 9, wherein the gelatin sheets have a top and bottom, and wherein the flavored composition is applied to the bottom of the sheets of gelatin.

17. The method of claim 9, wherein the gelatin sheets have a top and a bottom, and wherein the flavored composition is applied to the top and bottom of the sheets of gelatin.

18. An apparatus for applying a flavored composition to sheets of gelatin, the apparatus comprising:
a. a mechanism for generating sheets of gelatin;
b. a vessel holding a flavored composition;
c. a roller mechanism having perforations associated therewith, the roller mechanism being adjacent to the sheets of gelatin; and
d. a pump mechanism for delivering the flavored composition from the vessel to the roller mechanism.

19. The apparatus of claim 18, wherein the roller mechanism comprises a hollow body having an outer surface, the outer surface having perforations in flow communication with the hollow of the roller hollow body.

20. The apparatus of claim 18, wherein the roller mechanism includes a perforated application tube, a roller and a felt pad, wherein the application tube includes perforations therein, and wherein the application tube is disposed adjacent the roller felt pad.

21. The apparatus of claim 20, wherein the pump mechanism delivers the flavored composition to the application tube.

22. The apparatus of claim 21, wherein the flavored composition passes through the perforations in the application tube, onto the felt pad, and the felt pad is maintained in contact with the sheets of gelatin.

23. The apparatus of claim 19, wherein the flavored composition passes through the perforations in the hollow body and onto the sheets of gelatin.

24. The apparatus of claim 18, wherein the flavored composition is applied to top and bottom sides of the sheets of gelatin.

25. An apparatus for applying a flavored composition to sheets of gelatin, the apparatus comprising:
(a) a vessel holding the flavored composition;
(b) a sprayer for the flavored composition; and
(c) a pump for delivering the flavored composition from the vessel, through the sprayer, and onto the sheets of gelatin.

26. A method of making a softgel comprising the step of applying a flavored composition to a capsule after a fill is encapsulated.

27. The method of claim 26, wherein the flavored composition is applied in as the capsule is dried.

28. The method of claim 26, wherein the flavored composition is applied as the capsule is polished.
